(19) United States
(12) Patent Application Publication
(10) Pub. No.: US 2012/0180695 A1
(43) Pub. Date: Jul. 19, 2012

(54) O/W TYPE EMULSION INK COMPOSITION FOR BALLPOINT PENS

(76) Inventors: Akiko Itabashi, Chuo-ku (JP); Hideaki Shimizu, Chuo-ku (JP)

(21) Appl. No.: 13/497,541

(22) PCT Filed: Sep. 28, 2010
(86) PCT No.: PCT/JP2010/005810

§ 371 Date: Mar. 22, 2012

(30) Foreign Application Priority Data
Sep. 29, 2009 (JP) 2009-225643

(51) Int. Cl. C09D 11/18

(52) U.S. Cl. 106/31.25

(57) ABSTRACT

An Object of the present invention is to, provide an ink composition for a ballpoint pen which shows no offset of writing, offers writing with an excellent water resistance, and provides an excellent writing feeling. The present invention is an ON type emulsion ink composition for a ballpoint pen, comprising (A) an oil-based ink component comprising at least an oil-soluble dye as a colorant and an organic solvent capable of dissolving the dye and having a solubility of 5 g or less in 100 g of water at 20° C., (B) an emulsifier component comprising at least a polyglycerin fatty acid ester having an HLB of 8 or less, an acyllactic acid salt having 8 or more carbon atoms, and an organic amine compound, and (C) water, the components (A) and (B) being emulsified and dispersed in the water (C).

### TECHNICAL FIELD

The present invention relates to an O/W (oil-in-water) type emulsion ink composition for a ballpoint pen which offers writing with an excellent water resistance, shows no offset of writing, provides an excellent writing feeling, has a good temperature stability, and exhibits no deterioration with time such as precipitation.

### BACKGROUND ART

Although water-based inks for a ballpoint pen and water-based gel inks for a ballpoint pen containing a water-soluble dye have advantages of offering clear writing and providing a good writing feeling, these inks have disadvantage of offering writing with a low water resistance. Water-based pigment gel inks for a ballpoint pen using a pigment as a colorant to improve water resistance have a high ink viscosity for improving a writing density and preventing sedimentation, which results in a poor writing feeling. On the other hand, oil-based ballpoint pen inks prepared by dissolving an oil-soluble dye in an organic solvent offer writing with a good water resistance because of the water resistance of the dye; however, when the viscosity of the ink is decreased to achieve a good writing feeling, the organic solvent penetrates into paper and offset of writing occurs. Therefore, the viscosity is increased to prevent the offset, which leads to a heavy writing feeling.

Then, the present inventor considered that an O/W type emulsion ink for a ballpoint pen in which an oil phase component comprising an oil-soluble dye which is an colorant and an organic solvent is emulsified and dispersed in water by using an emulsifier would achieve a good writing feeling due to the water phase and water resistance due to the oil-soluble dye. As conventional techniques of an ink for writing instruments using such an O/W type emulsion, there have been proposed only special inks such as a colored liquid composition with polka-dotted appearance by using different colors for a water phase and an oil phase (Patent Literature 1), an ink using an unstable emulsion which irregularly changes the color of a written line by shaking (Patent Literature 2), an erasable ink prepared by dispersing liquid or paste droplets capable of giving a color in a solvent (Patent Literature 3), and so on. There have been proposed no inks which can be used for commonly used writing instruments for writing usual characters and such inks have not been found in the market.

### CITATION LIST

### Patent Literature

Patent Literature : Japanese Patent Laid-Open No. 2001-131458
Patent Literature 2: Japanese Patent Laid-Open No. 2004-323618
Patent Literature 3: Japanese Patent Laid-Open No. 2006-152186

### SUMMARY OF INVENTION

### Technical Problem

A non-ionic surfactant having a relatively higher HLB of about 8 to 18 is generally used as an emulsifier to produce an O/W type emulsion. However, using only the surfactant having a higher HLB leads to higher hydrophilicity, and then allows re-dissolution to water readily, which results in re-emulsification of the emulsion on writing when the writing gets wet with water, and thus, the writing cannot achieve sufficient water resistance even though an oil-soluble dye is used.

Furthermore, the emulsion using the surfactant having a higher HLB (hydrophilic-lipophilic balance) is sensitive to an environmental temperature, and thus suffers from problems of destruction and then agglomeration or separation to an oil phase and a water phase when the emulsion is placed under an environment of a high temperature to some degree.

An Object of the present invention is to provide an O/W type emulsion ink composition for a ballpoint pen comprising an oil-soluble dye as a colorant, which offers writing with an excellent water resistance, shows no offset of writing, provides an excellent writing feeling, has a good temperature stability, and exhibits no deterioration with time such as precipitation.

### Solution to Problem

An gist of the present invention is an O/W type emulsion ink composition for a ballpoint pen comprising (A) an oil-based ink component comprising at least an oil-soluble dye as a colorant and an organic solvent capable of dissolving the dye and having a solubility of 5 g or less in 100 g of water at 20° C., (B) an emulsifier component comprising at least a polyglycerin fatty acid ester having an HLB of 8 or less, an acyllactic acid salt having 8 or more carbon atoms, and an organic amine compound, and (C) water, the components (A) and (B) being emulsified and dispersed in the water (C).

### Advantageous Effects of Invention

As a result of diligent study, the present inventor found that the O/W type emulsion which is stable against temperature variation and over time when used as an ink for writing instruments can be produced by using the polyglycerin fatty acid ester having an HLB of 8 or less which is commonly used for producing a W/O type emulsion, in combination with the acyllactic acid salt having 8 or more carbon atoms.

The O/W type emulsion ink for which a solution of the oil-based dye is emulsified in water by using the combination of the polyglycerin fatty acid ester having an HLB of 8 or less and the acyllactic acid salt having 8 or more carbon atoms offers writing with an excellent water resistance and provides a light writing feeling because of a low viscosity of the ink.

Moreover, the problems such as gradual precipitation of a water-insoluble emulsifier component in a water phase to produce a turbid light-colored layer in an upper area of the ink when the ballpoint pen is left standing at normal temperature for a long period of time or especially stored in a low-temperature environment for a long period of time, lightening of color produced by a ballpoint pen at the beginning of writing due to gelation of the precipitates, or blurring of writing can be suppressed by adding the organic amine compound to the combination.

Furthermore, by using an amide-amine compound represented by the following general formula as the organic amine, because an acid amide group having an alkyl group having 11 to 18 carbon atoms is compatible with an organic solvent or especially with a polyglycerin fatty acid ester, precipitation of the polyglycerin fatty acid ester and the acyllactic acid salt which are emulsifiers from an emulsion interface into the water phase can be suppressed highly effectively by dissolving the amide-amine compound sufficiently in the oil phase.

Furthermore, by using a polyglycerin fatty acid ester containing a fatty acid having 18 or more carbon atoms and having an HLB of 10 or more in an amount of 0.1% by weight or more and 2% by weight or less, based on the total amount of the ink in addition to the polyglycerin fatty acid ester having an HLB of 8 or less and the acyllactic acid salt having 8 or more carbon atoms, re-emulsification of the ink does not occur when the writing gets wet with water and the stability of the emulsion at high temperatures is improved in comparison with the case of using only the polyglycerin fatty acid ester having an HLB of 8 or less, which seems to result from the fact that the polyglycerin fatty acid ester having an HLB of 10 or more which is soluble in water exists with its lipophilic group oriented to the surface of an oil droplet of the emulsion and strengthens the interface between the oil droplet and water from the water phase to further improve the heat resistance of the emulsion.

### Description of Embodiments

The polyglycerin fatty acid ester used in the present invention is a polyglycerin fatty acid ester having an HLB of 8 or less. When only a polyglycerin fatty acid ester having an HLB of more than 8 is used, the water resistance of writing decreases. A polyglycerin fatty acid ester which is solid at room temperature is preferred, and the ester which is liquid at room temperature sometimes offers a low stability of an emulsion at high temperatures.

Specific examples of the polyglycerin fatty acid ester used in the present invention include diglyceryl monostearate, diglyceryl monooleate, diglyceryl dioleate, diglyceryl monoisostearate, tetraglyceryl monostearate, tetraglyceryl monooleate, tetraglyceryl tristearate, tetraglyceryl pentastearate, hexaglyceryl tristearate, hexaglyceryl pentastearate, decaglyceryl tristearate, decaglyceryl trioleate, decaglyceryl pentastearate, decaglyceryl pentaisostearate, decaglyceryl pentaoleate, decaglyceryl heptabehenate, decaglyceryl decaoleate, and decaglyceryl dodecabehenate. The used amount of the polyglycerin fatty acid ester is preferably 0.01% by weight to 2.00% by weight, and these compounds can be used by mixing two or more.

The acyllactic acid salt used in the present invention is essential for producing an O/W type emulsion by using the polyglycerin fatty acid ester having an HLB of 8 or less which cannot generally produce the O/W type emulsion alone. The acyllactic acid salt preferably has 8 or more carbon atoms, and an acyllactic acid salt having less than 8 carbon atoms has a lower performance as an emulsifier and then a good emulsifier composition cannot be obtained. In addition, the acyllactic acid salt is preferably a sodium salt, and when an acyl lactic acid, a calcium salt thereof, or a magnesium salt thereof is used, precipitation or agglomeration of an oil-soluble dye may occur, which may lead to destruction of the emulsion. Examples of the acyllactic acid salt used in the present invention include caproyllactic acid salt, 2-ethylhexanoyllactic acid salt, lauroyllactic acid salt, myristoyllactic acid salt, palmitoyllactic acid salt, stearoyllactic acid salt, isostearoyllactic acid salt, oleoyllactic acid salt, 12-hydroxystearoyllactic acid salt, and lycinoreyl lactate, and especially sodium stearoyllactate and sodium isostearoyllactate are preferred. The used amount of the acyllactic acid salt is preferably 0.001% by weight to 2.00% by weight, and is especially preferably 0.05 or more and 20 or less parts to one part of the used amount of the polyglycerin fatty acid ester having an HLB of 8 or less. These compounds can be used by mixing two or more.

As the organic amine, for example, organic amines containing a hydroxyl group such as monoethanolamine, diethanolamine, triethanolamine, triisopropanolamine, 2-amino-2-methyl-1,3-propanediol, 2-amino-2-methyl-1-propanol, N-methyldiethanolamine, N,N-dimethylethanolamine, N,N-diethylethanolamine, N,N-dimethyl-1,3-propanediamine, N,N-dimethylaminoethanol, N,N-dimethylaminopropanol, and N,N-dimethylaminohexanol can be used because these amines are compatible with alcohol solvents and glycol ether solvents which are widely used for dissolving the dye. Other examples of the organic amine include morpholine, aniline, benzylamine, m-phenylenediamine, p-phenylenediamine, methylphenylenediamine, butylamine, pentylamine, tetramethylenediamine, cyclohexylamine, 3-butoxypropylamine, dimethylaminopropylamine, methylamine, dimethylamine, trimethylamine, ethylamine, diethylamine, triethylamine, dipropylamine, N,N,N′N′-tetramethylethylenediamine, ethylenediamine, diethylenetriamine, triethylenetetramine, tetraethylenepentamine, diethylaminopropylamine, dimethylethylenediamine, hexamethylenediamine, methylpentamethylenediamine, trimethylhexamethylenediamine, guanidine, isophoronediamine, piperidine, N,N′-dimethylpiperazine, N-aminoethylpiperazine, 1,2-diaminocyclohexane, DBU (diazabicycloundecene), metaphenylenediamine, 4,4′-diaminodiphenylsulfone, xylylenediamine(meta), benzyldimethylamine, and N-methylmorpholine.

Especially, a water-insoluble organic amine can highly effectively suppress precipitation of the polyglycerin fatty acid ester or the acyllactic acid salt which are water-insoluble at the emulsion interface between the oil phase and the emulsifier into the water phase because such an amine is dissolved selectively in the oil phase. As the water-insoluble organic amine, octylamine, laurylamine, myristylamine, stearylamine, N-N-dimethyllaurylamine, N-N-dimethylmyristylamine, N-N-dimethylpalmitylamine, N-N-dimethylstearylamine, N-N-dimethylbehenylamine, oleylamine, 4 ,4 ′-diaminodiphenylmethane, 1-naphthylamine, o-phenylenediamine, hexylamine, cetylamine, dibutylamine, dodecylamine, dicyclohexylamine, di(2-ethylhexyl)amine, 2-ethylhexylamine, 3-(2-ethylhexyloxy)propylamine, dibutylaminopropylamine, 1,3-diphenylguanidine, ditolylguanidine, tripropylamine, tributylamine, diisopropylethylamine, dihexylamine; and rosinamines such as dihydroabiethylamine, tetrahydroabiethylamine, pimarylamine, dihydropimarylamine, tetrahydropimarylamine, isopimarylamine, dihydroisopimarylamine, tetrahydroisopimarylamine, and cocodimethylamine are arbitrarily used.

The amide-amine compound represented by the following general formula, especially behenic acid amidepropyldimethylamine, stearic acid dimethylaminopropylamide, and stearic acid diethylaminoethylamide is considered to suppress the precipitation of the compounds highly effectively because these amines have a higher compatibility with a fatty acid derivative moiety in a emulsifier component due to the presence of not only an amine structure but also a fatty acid amide group, though the reaction mechanism is not known specifically.

The used amount of the organic amine is preferably 0.001% by weight to 5.0% by weight. Depending on the structure of the dye used, the precipitation cannot be suppressed sufficiently when the used amount is too small and the pH of the ink becomes too high, which may leads to the precipitation of the dye especially in the case of a salt-forming dye due to its structure becoming unstable, when the used amount is too large. When the pH of the ink rises to about 9 or more by adding the organic amine, the pH of the emulsion ink is preferably kept at about 4.5 to 9 by arbitrarily using a known pH adjustor.

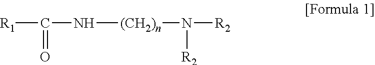

In the formula, R₁ represents an alkyl group having 11 to 23 carbon atoms, R₂ represents an alkyl group having 1 to 4 carbon atoms, and n represents an integer of 2 to 4.

Examples of a polyglycerin fatty acid ester containing a fatty acid having 18 or more carbon atoms and having an HLB of 10 or more which is additionally used include decaglyceryl monostearate, decaglyceryl monoisostearate, decaglyceryl monooleate, decaglyceryl monolinoleate, and decaglyceryl diisostearate. The used amount of the polyglycerin fatty acid ester is preferably 0.01% by weight to 2.00% by weight, and these compounds can be used in combination of two or more.

A polyglycerin fatty acid ester containing a fatty acid having less than 18 carbon atoms would decrease the stability of the emulsion at high temperatures even if the polyglycerin fatty acid ester has an HLB of 10 or more. When the added amount exceeds 2% by weight, offset of the writing may be increased or the re-emulsification of the ink may occur when the writing gets wet with water, which may lead to a decrease in the water resistance.

Moreover, when the fatty acid has a short carbon chain such as a chain of less than 18 carbon atoms, it is assumed that an interface having a sufficient thickness cannot be obtained, which impairs the heat resistance.

As a colorant, a dye which has been conventionally used for an oil-based ink for a ballpoint pen can be used with no limitation. As the dye, acid dyes, basic dyes, metal complex salt dyes, salt-forming dyes, azine dyes, anthraquinone dyes, phthalocyanine dyes, and triphenylmethane dyes, etc., can be used, and specifically, VALIFAST YELLOW #3104, VALIFAST YELLOW #3105, VALIFAST YELLOW #1105, VALIFAST YELLOW AUM, ORIENT SPIRIT BLACK AB, VALIFAST BLACK #3804, VALIFAST BLACK #3806, VALIFAST BLACK #1802, VALIFAST BLACK #1805, VALIFAST YELLOW #1109, VALIFAST ORANGE #2210, VALIFAST RED #1320, VALIFAST BLUE #1605, VALIFAST VIOLET #1701, ORIENT OIL SCARLET #308, and NIGROSINE BASE EX-BP (oil-based dyes manufactured by ORIENT CHEMICAL INDUSTRIES CO., LTD.); Spilon black GMH special, Spilon yellow C-2GH, Spilon red C-GH, Spilon red C-BH, Spilon blue BPNH, Spilon blue C-RH, Spilon violet C-RH, S.P.T. orange 6, and S.P.T. blue -111 (oil-based dyes manufactured by HODOGAYA CHEMICAL CO., LTD.); Rhodamine B Base (C.I.45170B, an oil-based dye manufactured by Sumitomo Chemical Co., Ltd.); Victoria Blue F4R and Nigrosine Base LK (manufactured by BASF SE in Germany); and Methyl Violet 2B Base (manufactured by National Anilne Div. in the United States), etc. can be used.

These compounds can be used alone or in mixture of two or more. An oil-based component in the O/W type emulsion should be an ink component in which at least the oil-soluble dye as a colorant is dissolved in an organic solvent, and the added amount of the oil-soluble dye is 5% by weight or more and 50% by weight or less, and preferably 10% by weight or more and 45% by weight or less, based on the amount of the oil-based component. When the used amount is small, the emulsion produced offers a light writing density, and when the used amount is large, the oil-soluble dye is not dissolved in the organic solvent and the oil-based component portion becomes unstable, which may leads to a decrease in the heat stability of the emulsion.

As the solvent used in the oil-based component in the emulsion, an organic solvent which has been conventionally used for oil-based ballpoint pens, is capable of dissolving the oil-soluble dye, and has a solubility of 5 g or less in 100 g of water at 20° C. and thus is not substantially soluble in water can be used. For example, ethylene glycol monoether solvents such as ethylene glycol monohexyl ether, ethylene glycol mono-2-ethylhexyl ether, ethylene glycol monophenyl ether, and ethylene glycol monobenzyl ether; diethylene glycol monoether solvents such as diethylene glycol monohexyl ether, diethylene glycol mono-2-ethylhexyl ether, and diethylene glycol monophenyl ether; propylene glycol monoether solvents such as propylene glycol monophenyl ether, dipropylene glycol mononormalpropyl ether, dipropylene glycol monobutyl ether, and tripropylene glycol monobutyl ether; and alcohol solvents such as benzyl alcohol, β-phenylethyl alcohol, and octylene glycol can be used. These compounds can be used alone or in mixture of two or more. In order to achieve clear writing with a high density, the organic solvent is preferably one capable of dissolving the oil-soluble dye in an amount of 30% by weight or more. The blended amount of the organic solvent is 1% by weight or more and 90% by weight or less, based on the amount of the oil, phase of the emulsion ink composition.

A resin which has been conventionally used for oil-based ballpoint pens and is soluble in the organic solvent capable of dissolving the oil-soluble dye may further be used as the oil-based component in order to improve fixation of the dye on a paper surface, promote the dissolution of the dye, and improve a color development. Specific examples of the resin include an acryl resin, an acrylic acid resin, a maleic acid resin, a copolymer of styrene and maleic acid ester, a copolymer of styrene and acrylic acid or an ester thereof, a urea resin, a polyvinyl butyral, a polyvinyl acetal, a polyamide resin, an ester gum, a polyester resin, an alkyd resin, a polyurethane resin, an epoxy resin, a polyvinyl alkyl ether, a coumarone-indene resin, polyterpene, a rosin resin or a hydrogen additive thereof, a ketone resin, a terpene-phenol copolymer, a polyacrylate-polymethacrylate copolymer, a phenol resin, a polyethylene oxide, polyvinyl pyrrolidone, N-vinyl acetamide, ethyl cellulose, hydroxyethyl cellulose, hydroxypropyl cellulose, ethylhydroxyethyl cellulose, copolymers thereof, or various derivatives thereof. These resins can be used alone or in mixture of two or more, and the blended amount of the resin is preferably 0.1% by weight or more and 50% by weight or less, based on the amount of the oil phase of the emulsion ink composition. When the added amount of the resin is too large and the viscosity of the oil-based component becomes too high, an emulsion having a uniform and fine particle size may not be produced during emulsification.

In order to produce an emulsion which is stable without being affected by water in the water phase, a ketone resin or a polyvinyl butyral resin is especially preferred.

Water is used as an essential component in the O/W type emulsion ink. The water is preferably ion-exchange water in view of dissolving the dye or the resin stably.

In addition to these essential components, conventionally known viscosity modifiers, dissolution promoters of the dye, various resins or resin emulsions as an fixative, antioxidizing agents, ultraviolet absorbing agents, preservative agents, rust preventive agents, antifoaming agents, pH adjustors, or lubricant agents for preventing abrasion at a ball seat or imparting smooth writing can be used for both of the oil phase and the water phase arbitrarily as needed.

Especially, in order to prevent drying or freezing of the ink, a water-based component preferably comprises a water-soluble organic solvent or polyhydric alcohols, and specifically a water-soluble organic solvent such as ethylene glycol, diethylene glycol, triethylene glycol, :propylene glycol, dipropylene glycol, polyethylene glycol, polypropylene glycol, 1,3-butylene glycol, thiodiethylene glycol, glycerin, diglycerin, triglycerin and tetraglycerin; and a polyhydric alcohol such as sorbitol, maltitol, and fructose can be used. The blended amount of these compounds is preferably 50% by weight or less, based on the total amount of the water-based component.

In order to provide a viscosity and rheological properties desirable for a ballpoint pen ink, a high molecular polysaccharide, a water-soluble and water-swellable acrylic resin, and an inorganic mineral viscosity improver, etc., can be used in the water-based component. A substance which can be neutralized and provide the desirable viscosity and rheological properties, such as an acrylate resin, can be used in the ink after neutralization using a conventionally known inorganic base or a conventionally known organic base as well as the aforementioned organic amine.

The O/W type emulsion ink preferably comprises, based on the total amount of the emulsion ink, 10% by weight or more and 50% by weight or less of the oil-based component comprising the oil-soluble dye, 0.1% by weight or more and 15% by weight or less of the emulsifier component which is a mixture of the polyglycerin fatty acid ester having an HLB of 8 or less, the acyllactic acid salt, and the organic amine compound, and 20% by weight or more and 75% by weight or less of the water-based component.

There is no restriction on an emulsifying and dispersing method for producing the O/W type emulsion ink, and the O/W type emulsion ink can be produced by carrying out stirring using a stirrer, a homomixer, a homogenizer, or the like at an appropriate temperature. The produced emulsion can be processed using a high-pressure homogenizer in order to obtain a finer emulsion. Filtration or a centrifugal process can be employed in order to uniform the particle size of the emulsion or remove an insoluble substance.

In order to dissolve the polyglycerin fatty acid ester having an HLB of 8 or less and the acyllactic acid salt sufficiently in the oil phase and produce the emulsion in a liquid state, it is preferred to keep the temperature at 70° C. or more at the beginning of stirring for emulsification. Moreover, it is preferred to sufficiently heat and dissolve the organic amine preliminarily in the oil-based ink component with the polyglycerin fatty acid ester having an HLB of 8 or less and the acyllactic acid salt in order to attain a higher compatibility with the emulsifier component.

### EXAMPLES

### Example 1

| | | |
|---|---|---|
| Spilon yellow C-GNH (colorant: manufactured by | 3.2% | by weight |
| HODOGAYA CHEMICAL CO., LTD.) | | |
| Spilon red C-GH (colorant: manufactured by | 1.6% | by weight |
| HODOGAYA CHEMICAL CO., LTD.) | | |
| Spilon blue C-RH (colorant: manufactured by | 3.2% | by weight |
| HODOGAYA CHEMICAL CO., LTD.) | | |
| benzyl alcohol | 10.0% | by weight |
| decaglyceryl pentastearate (HLB = 3.5) | 0.8% | by weight |
| sodium stearoyllactate | 0.2% | by weight |
| decaglyceryl diisostearate (HLB = 10.0) | 0.5% | by weight |
| stearic acid dimethylaminopropylamide (amide-amine | 0.1% | by weight |
| MPS manufactured by Nikko Chemicals Co., Ltd.) | | |
| glycerin | 5.0% | by weight |
| ion-exchange water | 75.4% | by weight |

Liquid A was produced by heating and stirring the above components other than glycerin and ion-exchange water at 85° C. for 3 hours. Liquid B was produced by stirring glycerin and ion-exchange water at 20° C. for 10 minutes. The liquid B was heated to 80° C., and then, the liquid A was added to the liquid B while keeping the temperature at 80° C. and the obtained liquid was stirred by using a magnetic stirrer for 10 minutes. After that, treatment using a high-pressure homogenizer was carried out over three passes while cooling the liquid to 20° C., thus producing a black emulsion ink.

### Example 2

| | | |
|---|---|---|
| Spilon yellow C-GNH (colorant: manufactured by | 1.10% | by weight |
| HODOGAYA CHEMICAL CO., LTD.) | | |
| Spilon red C-GH (colorant: manufactured by | 1.70% | by weight |
| HODOGAYA CHEMICAL CO., LTD.) | | |
| Spilon red C-BH (colorant: manufactured by | 2.20% | by weight |
| HODOGAYA CHEMICAL CO., LTD.) | | |
| benzyl alcohol | 7.00% | by weight |
| ethylene glycol monophenyl ether | 2.00% | by weight |
| hexaglyceryl tristearate (HLB = 2.5) | 1.00% | by weight |
| sodium isostearoyllactate | 0.25% | by weight |
| decaglyceryl monooleate (HLB = 12.0) | 0.50% | by weight |
| stearic acid diethylaminoethylamide (amide-amine | 0.20% | by weight |
| SV manufactured by Nikko Chemicals Co., Ltd.) | | |
| ethylene glycol | 3.00% | by weight |
| ion-exchange water | 81.05% | by weight |

Liquid A was produced by heating and stirring the above components other than ethylene glycol and ion-exchange water at 80° C. for 1 hour. Liquid B was produced by stirring ethylene glycol and ion-exchange water at 20° C. for 30 minutes. The liquid B was heated to 75° C., and then, the liquid A was put into the liquid B by drops while stirring the liquid by a homogenizer. After that, the obtained liquid was stirred at 75° C. for 15 minutes, and then, cooled while being stirred, thus producing a red emulsion ink.

### Example 3

| | | |
|---|---|---|
| Spilon yellow C-GNH | 4.00% | by weight |
| Spilon red C-BH | 1.00% | by weight |
| ethylene glycol monophenyl ether | 15.00% | by weight |
| decaglyceryl pentastearate (HLB = 3.5) | 1.50% | by weight |
| sodium stearoyllactate | 0.30% | by weight |
| decaglyceryl monooleate (HLB =12.0) | 0.30% | by weight |
| stearic acid dimethylaminopropylamide | 0.1% | by weight |
| glycerin | 5.00% | by weight |
| ion-exchange water | 72.80% | by weight |

Liquid A was produced by heating and stirring the above components other than glycerin and ion-exchange water at 80° C. for 3 hours. Glycerin and ion-exchange water were heated to 80° C., and then, the liquid A was put thereinto by drops while stirring the liquid by using a homogenizer, and the obtained liquid was processed for 5 minutes. After that, treatment using a high-pressure homogenizer was carried out over three passes while cooling the liquid to 20° C., thus producing an orange emulsion ink.

### Example 4

A black emulsion ink was produced as in a similar manner to that described in Example 1 except that the total amount of decaglyceryl diisostearate (HLB=10.0) was replaced by benzyl alcohol.

### Example 5

A red emulsion ink was produced as in a similar manner to that described in Example 2 except that the total amount of decaglyceryl monooleate (HLB=12.0) was replaced by ethylene glycol monophenyl ether.

### Example 6

An orange emulsion ink was produced as in a similar manner to that described in Example 3 except that the total amount of stearic acid dimethylaminopropylamide was replaced by triethanolamine.

### Example 7

| | | |
|---|---|---|
| Spilon yellow C-GNH | 10.00% | by weight |
| ethylene glycol monophenyl ether | 20.00% | by weight |
| decaglyceryl pentastearate (HLB = 3.5) | 1.50% | by weight |
| calcium stearoyllactate | 0.30% | by weight |
| decaglyceryl diisostearate (HLB = 10.0) | 0.50% | by weight |
| stearylamine | 0.10% | by weight |
| glycerin | 5.00% | by weight |
| ion-exchange water | 62.60% | by weight |

Liquid A was produced by heating and stirring the above components other than glycerin and ion-exchange water at 80° C. for 3 hours. Glycerin and ion-exchange water were heated to 80° C., and then, the liquid A was put thereinto by drops while stirring the liquid by using a homogenizer, and the obtained liquid was processed for 5 minutes. After that, treatment using a high-pressure homogenizer was carried out over three passes while cooling the liquid to 20° C., thus producing a yellow emulsion ink.

### Example 8

An orange emulsion ink was produced as in a similar manner to that described in Example 3 except that the total amount of decaglyceryl monooleate (HLB=12.0) was replaced by ethylene glycol monophenyl ether and the total amount of stearic acid dimethylaminopropylamide was replaced by triethanolamine.

### Example 9

A yellow emulsion ink was produced as in a similar manner to that described in Example 7 except that the total amount of decaglyceryl diisostearate (HLB=10.0) was replaced by ethylene glycol monophenyl ether.

### Example 10

| | | |
|---|---|---|
| VALIFAST YELLOW 1171 (colorant: manufactured | 10.00% | by weight |
| by ORIENT CHEMICAL INDUSTRIES CO., LTD.) | | |
| benzyl alcohol | 15.00% | by weight |
| decaglyceryl pentastearate (HLB = 3.5) | 1.50% | by weight |
| calcium stearoyllactate | 0.30% | by weight |
| decaglyceryl diisostearate (HLB = 10.0) | 0.50% | by weight |
| ditolylguanidine | 0.10% | by weight |
| resin SK (ketone resin: manufactured by | 5.00% | by weight |
| Evonik Degussa Japan Co., Ltd.) | | |
| glycerin | 5.00% | by weight |
| ion-exchange water | 62.60% | by weight |

Liquid A was produced by heating and stirring the above components other than glycerin and ion-exchange water at 80° C. for 3 hours. Glycerin and ion-exchange water were heated to 80° C., and then, the liquid A was put thereinto by drops while stirring the liquid by using a homogenizer, and the obtained liquid was processed for 5 minutes. After that, treatment using a high-pressure homogenizer was carried out over three passes while cooling the liquid to 20° C., thus producing a yellow emulsion ink.

### Example 11

| | | |
|---|---|---|
| VALIFAST YELLOW 1171 (colorant: manufactured | 10.00% | by weight |
| by ORIENT CHEMICAL INDUSTRIES CO., LTD.) | | |
| benzyl alcohol | 15.00% | by weight |
| decaglyceryl pentastearate (HLB = 3.5) | 1.50% | by weight |
| calcium stearoyllactate | 0.30% | by weight |
| decaglyceryl diisostearate (HLB = 10.0) | 0.50% | by weight |
| ethylenediamine | 0.10% | by weight |
| resin SK | 5.00% | by weight |
| glycerin | 5.00% | by weight |
| ion-exchange water | 47.60% | by weight |
| 2% aqueous solution of Pemulen TR-2 | 10.00% | by weight |
| 20% aqueous solution of sodium hydroxide | 5.00% | by weight |

2% by weight of Pemulen TR-2 (water-swellable acrylic resin, manufactured by Nikko Chemicals Co., Ltd.) was added to 98% by weight of ion-exchange water drop by drop with being stirred by using a three-one motor and the obtained solution was stirred for 2 hours, thus producing 2% aqueous solution of Pemulen TR-2. Liquid A was produced by heating and stirring the above components other than glycerin, ion-exchange water, the 2% aqueous solution of Pemulen TR-2, and 20% aqueous solution of sodium hydroxide at 80° C. for 3 hours. Glycerin and ion-exchange water were heated to 80° C., and then, the liquid A was put thereinto by drops while stirring the liquid by using a homogenizer, and the obtained liquid was processed for 5 minutes. After that, treatment using a high-pressure homogenizer was carried out over three passes while cooling the liquid to 20° C. The 2% aqueous solution of Pemulen TR-2 was added to the treated liquid while stirring the liquid by using a three-one motor, and the obtained liquid was stirred at 25° C. for 2 hours. After that, the Pemulen TR-2 was neutralized to increase the viscosity by adding 20% aqueous solution of sodium hydroxide drop by drop. After increasing the viscosity, the obtained liquid was stirred at 25° C. for 1 hour, and then, pressured filtration was conducted by using 5A filter paper to remove insoluble or floury lumps of Pemulen, wetted only on the outside, thus producing a yellow emulsion ink.

### Comparative Example 1

| | | |
|---|---|---|
| Spilon yellow C-GNH (colorant: manufactured by | 3.2% | by weight |
| HODOGAYA CHEMICAL CO., LTD.) | | |
| Spilon red C-GH (colorant: manufactured by | 1.6% | by weight |
| HODOGAYA CHEMICAL CO., LTD.) | | |
| Spilon blue C-RH (colorant: manufactured by | 3.2% | by weight |
| HODOGAYA CHEMICAL CO., LTD.) | | |
| benzyl alcohol | 10.0% | by weight |
| decaglyceryl pentastearate (HLB = 3.5) | 0.8% | by weight |
| sodium stearoyllactate | 0.2% | by weight |
| decaglyceryl diisostearate (HLB = 10.0) | 0.5% | by weight |
| stearic acid dimethylaminopropylamide | 0.1% | by weight |
| PVP K-90 (polyvinylpyrrolidone: | 0.7% | by weight |
| manufactured by ISP Japan Ltd.) | | |
| ethylene glycol monophenyl ether | 79.7% | by weight |

The above components were heated and stirred at 80° C. for 3 hours to dissolve the dye, thus producing a black oil-based ink.

### Comparative Example 2

| | | |
|---|---|---|
| WATER PINK #2 (C.I.ACID RED 92 manufactured | 5.0% | by weight |
| by ORIENT CHEMICAL INDUSTRIES CO., LTD.) | | |
| WATER YELLOW #6C (C.I.ACID YELLOW 23 | 1.0% | by weight |
| manufactured by ORIENT CHEMICAL | | |
| INDUSTRIES CO., LTD.) | | |
| Kelzan AR | 0.5% | by weight |
| ethylene glycol | 25.0% | by weight |
| glycerin | 10.0% | by weight |
| Sarcosinate OH (N-oleoyl sarcosine, surfactant, | 1.0% | by weight |
| manufactured by Nikko Chemicals Co., Ltd.) | | |
| triethanolamine | 0.3% | by weight |
| ion-exchange water | 57.2% | by weight |

A Kelzan AR aqueous solution was prepared by stirring Kelzan AR and water for 30 minutes by using a lab mixer to dissolve Kelzan AR uniformly, and then, the remaining components were added thereto and mixing and stirring were conducted for 2 hours, thus producing a water-based dye red ink.

### Comparative Example 3

A black emulsion ink was produced as in a similar manner to that described in Example 1 except that the total amount of stearic acid dimethylaminopropylamide was replaced by benzyl alcohol.

### Comparative Example 4

A red emulsion ink was produced as in a similar manner to that described in Example 2 except that the total amount of stearic acid diethylaminoethylamide was replaced by benzyl alcohol.

### Comparative Example 5

A yellow emulsion ink was produced as in a similar manner to that described in Example 7 except that the total amount of decaglyceryl diisostearate (HLB=10.0) and calcium stearoyllactate was replaced by ethylene glycol monophenyl ether. However, the emulsion ink could not be produced because the viscosity of the ink suddenly increased during stirring and cooling by a homogenizer and stirring could not be continued. The type of the emulsion was checked by putting the ink into ion-exchange water by drops, and phase transition to a W/O type emulsion was confirmed by the result that the ink was not dispersed in water and separated.

### Comparative Example 6

A black emulsion ink was produced as in a similar manner to that described in Example 1 except that the total amount of decaglyceryl pentastearate (HLB=3.5) and calcium stearoyllactate was replaced by benzyl alcohol.

### Observation of Initial State

A drop of the emulsion ink was put into 10 g of ion-exchange water and stirred briefly, and the case in which the drop of the emulsion ink was separated from water was judged as W/O type emulsion and the case in which the drop of the emulsion ink was dispersed uniformly in water was judged as O/W type emulsion.

Measurement of Particle size

In Examples 1 to 11 and Comparative Examples 3, 4 and 6 in which the produced emulsion ink was an O/W type emulsion ink, the emulsion ink was diluted by ion-exchange water and particle size distribution was measured by using SALD-7100 which was a laser diffraction particle size distribution analyzer manufactured by SHIMADZU CORPORATION at 20° C. and the median size was adopted as an average particle size.

Measurement of Particle Size after Lapse of Time at High Temperature of 40° C.

In Examples 1 to 11 and Comparative Examples 3, 4 and 6 in which the produced emulsion ink was an O/W type emulsion ink, 10 g of the ink was put into a screw-top glass bottle with a cap (19×70 mm, manufactured by NICHIDEN-RIKA GLASS CO., LTD.), left at 40° C. for 1 month, and then left to stand at 20° C. for 5 hours. After that, a particle size after lapse of time was measured as in a similar manner to that described in the measurement of particle size.

Confirmation of Precipitation after 1 week at 5° C.

In Examples 1 to 11 and Comparative Examples 3, 4 and 6 in which the produced emulsion ink was an O/W type emulsion ink, 10 g of the ink was put into a screw-top glass bottle with a cap (19×70 mm, manufactured by NICHIDEN-RIKA GLASS CO., LTD.), left at 5° C. for 1 week, and then left to stand at 20° C. for 5 hours. After that, appearance was observed and an upper area of the emulsion ink was taken on a glass slide in a small amount and observed at 200-fold magnification by using a microscope.

White turbid at upper area: the upper area of the emulsion was white turbid at the observation of appearance and a large quantity of precipitates were observed at the observation using a microscope

Precipitates observed: precipitates were observed at the observation using a microscope, while the emulsion ink was uniform in appearance.

Precipitates not observed: no precipitates were observed at both of the observation of appearance and the observation using a microscope

Confirmation of Precipitation after 1 Month at 5° C.

In. Examples 1 to 11 and Comparative Examples 3, 4 and 6 in which the produced emulsion ink was an O/W type emulsion ink, 10 g of the ink was put into a screw-top glass bottle with a cap (19 x 70 mm, manufactured by NICHIDEN-RIKA GLASS CO., LTD.), left at 5° C. for 1 month, and then left to stand at 20° C. for 5 hours. After that, precipitation was observed as in a similar procedure to that for the confirmation of precipitation after 1 week at 5° C.

### Production of Test Sample

1.7 g of the ink composition for a ballpoint pen produced in each of Examples 1 to 11 and Comparative Examples 1 to 4 and 6 was filled in a container tube of a retractable ballpoint pen with a pen tip holding a super hard ball having a diameter of 0.5 mm (retractable type ENERGEL, product code BLN75, manufactured by PENTEL CO., LTD.), and provided as a ballpoint pen sample for a test.

### Water Resistance Test of Writing

After continuous 15 circles each having a diameter of about 2 cm were drawn by hand twice on writing paper A specified in JIS P3201 by using the ballpoint pen test samples, the paper was left to stand for 1 hour and then immersed into ion-exchange water for 1 hour. After that, the paper was taken from water and degree of color deterioration was assessed by means of gray scale (JIS L-0804). The gray scale was graded in 1 to 5 levels, and a larger number indicates that the difference in writing density between before and after the test is smaller, which indicates that the water resistance is higher.

### Offset of Writing

After continuous 15 circles each having a diameter of about 2 cm were drawn by hand twice on writing paper A specified in JIS P3201 by using the ballpoint pen test samples, the paper was left to stand under an environment at 30° C. and 60% RH for 1 day and then the back of the writing paper was observed.

The case in which the ink does not penetrate into the paper was evaluated as “\textcircled{◯}”

the case in which the ink slightly penetrates into the paper was evaluated as “◯”, and

the case in which the ink apparently penetrates into the paper was evaluated as “×”.

The results of the tests are shown in Table 1.

TABLE 1

| | Initial State | | Particle size | Precipitation | Precipitation | | |
|---|---|---|---|---|---|---|---|
| | (type of | Particle | after 1 month | after 1 week | after 1 month | Water resistance | Offset |
| | emulsion) | size (μm) | at 40° C. (μm) | at 5° C. | at 5° C. | test of writing | of writing |
| Example 1 | O/W | 0.86 | 0.95 | Not observed | Not observed | 4 | ⊚ |
| Example 2 | O/W | 0.72 | 0.83 | Not observed | Not observed | 3.5 | ⊚ |
| Example 3 | O/W | 0.69 | 0.79 | Not observed | Not observed | 3.5 | ⊚ |
| Example 4 | O/W | 1.10 | 1.35 | Not observed | Not observed | 4 | ⊚ |
| Example 5 | O/W | 0.92 | 1.10 | Not observed | Not observed | 3.5 | ⊚ |
| Example 6 | O/W | 0.85 | 0.92 | Not observed | Observed | 3.5 | ⊚ |
| Example 7 | O/W | 0.79 | 0.86 | Not observed | Observed | 3.5 | ⊚ |
| Example 8 | O/W | 1.02 | 1.62 | Not observed | Observed | 3.5 | ◯ |
| Example 9 | O/W | 0.95 | 1.77 | Not observed | Observed | 3.5 | ⊚ |
| Example 10 | O/W | 0.66 | 0.73 | Not observed | Observed | 3.5 | ⊚ |
| Example 11 | O/W | 0.71 | 0.76 | Not observed | Observed | 3.5 | ⊚ |
| Comparative | Oil-based | — | — | — | — | 4 | X |
| Example 1 | | | | | | | |
| Comparative | Water-based | — | — | — | — | 1 | ⊚ |
| Example 2 | | | | | | | |
| Comparative | O/W | 1.01 | 1.15 | White turbid | White turbid | 4 | ◯ |
| Example 3 | | | | at upper area | at upper area | | |
| Comparative | O/W | 0.92 | 1.03 | White turbid | White turbid | 3.5 | ◯ |
| Example 4 | | | | at upper area | at upper area | | |
| Comparative | W/O phase | — | — | — | — | — | — |
| Example 5 | transition | | | | | | |
| Comparative | O/W | 1.22 | Separation | Not observed | Not observed | 3 | ◯ |
| Example 6 | | | into two phase | | | | |

Although the ink produced in Comparative Example 1 is an oil-based ink with a low viscosity and offers writing with an excellent water resistance, the ink shows a large amount of offset.

Although the ink produced in Comparative Example 2 is a water-based gel ink and shows no offset, the ink offers writing with a lower water resistance.

Although the ink produced in Comparative Examples 3 and 4 is an emulsion ink and therefore shows no offset and offers a good water resistance, precipitates appear in the ink at low temperatures and the ink has a lower stability because the organic amine is not added.

In Comparative Example 5 where emulsification is carried out by using only the polyglycerin fatty acid ester having an HLB of 8 or less and not using the acyllactic acid salt as the emulsifier, phase separation into two phases occurs after phase transition to an O/W type emulsion and an ink cannot be produced. On the other hand, in Comparative Example 6 where emulsification is carried out by using only polyglycerin fatty acid ester having an HLB of over 8, an emulsion ink can be produced; however the emulsifier having a high HLB is re-emulsified on writing at the water resistance test, which indicates an insufficient water resistance, and the emulsion has a low stability at high temperatures.

In comparison with the Comparative Examples described above, the ink produced in Examples 1 to 11 offers writing with an excellent water resistance because the oil-based dye is used, and shows less offset because the ink is an emulsion ink. The ink exhibits a good performance such that no precipitates are observed after being left for 1 week at 5° C. because the organic amine is added.

Especially in Examples 1 to 5 where the amide-amine compound is added, the result shows that the precipitation is highly effectively suppressed even if the rest period at a low temperature becomes long. In Examples 1 to 3, 6, 7, 10, and 11 where the polyglycerin fatty acid ester having 18 or more carbon atoms and an HLB of 10 or more is additionally used in a small amount, a change in the particle size after lapse of time at 40° C. is small, which indicates that the stability of the emulsion at high temperatures is improved without impairing the water resistance of writing.

As described above in detail, the O/W type emulsion ink composition of the present invention exhibits no ink deterioration at low temperatures such as precipitation, exhibits a good stability with lapse of time at room temperature over a long period of time because the ink composition has less change in the particle size even after heated at 40° C. for a long period of time and then has an excellent temperature stability, exhibits a good performance on offset and water resistance of writing, and provides an excellent writing feeling.

### INDUSTRIAL APPLICABILITY

According to the present invention, it is possible to provide an O/W type emulsion ink composition for a ballpoint pen comprising a oil-soluble dye as a colorant, which offers writing with an excellent water resistance, shows no offset of writing, exhibits excellent writing feeling, has a good temperature stability, and exhibits no deterioration with time such as precipitation.

1. An O/W type emulsion ink composition for a ballpoint pen, comprising (A) an oil-based ink component comprising at least an oil-soluble dye as a colorant and an organic solvent capable of dissolving the dye and having a solubility of 5 g or less in 100 g of water at 20° C., (B) an emulsifier component comprising at least a polyglycerin fatty acid ester having an HUB of 8 or less, an acyllactic acid salt having 8 or more carbon atoms, and an organic amine compound, and (C) water, the components (A) and (B) being emulsified and dispersed in the water (C).

2. The O/W type emulsion ink composition for a ballpoint pen according to claim 1, wherein the organic amine is an amide-amine compound represented by the following general formula: 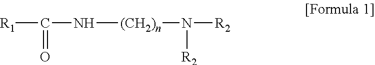
wherein R₁ represents an alkyl group having 11 to 23 carbon atoms, R₂ represents an alkyl group having 1 to 4 carbon atoms, and n represents an integer of 2 to 4.

3. (canceled)
